(19) United States
(12) Patent Application Publication
(10) Pub. No.: US 2013/0009547 A1
(43) Pub. Date: Jan. 10, 2013

(54) LED DRIVING CIRCUIT WITH OPEN-CIRCUIT PROTECTION

(75) Inventors: Shian-Sung Shiu, New Taipei City (TW); Chen-Hsung Wang, New Taipei City (TW)

(73) Assignee: GREEN SOLUTION TECHNOLOGY CO., LTD., New Taipei City (TW)

(21) Appl. No.: 13/286,227

(22) Filed: Nov. 1, 2011

(30) Foreign Application Priority Data
Jul. 5, 2011 (TW) 100123717

(51) Int. Cl. H05B 37/02

(52) U.S. Cl. 315/125

(57) ABSTRACT

An LED driving circuit with open-circuit protection is disclosed. The LED driving circuit pulls down an operation voltage supplied to a converting controller of the LED driving circuit when a voltage across an LED module of the LED driving circuit is too high, so as to stop the converting controller operating and further latch the converting controller at the protection state until that the converting controller is restarted or the condition of the voltage supplied to the LED module being too high is solved.

### CROSS-REFERENCE TO RELATED APPLICATION

This application claims the priority benefit of Taiwan application serial no. 100123717, filed on Jul. 5, 2011. The entirety of the above-mentioned patent application is hereby incorporated by reference herein and made a part of this specification.

### BACKGROUND OF THE INVENTION

1. Field of the Invention

The present invention relates to an LED driving circuit, and more particularly relates to an LED driving circuit with open-circuit protection.

2. Description of Related Art

FIG. 1 is a schematic diagram of an LED driving circuit. The LED driving circuit comprises a converting controller 10, an inductance L, a diode D, an output capacitance C, a transistor switch SW, a current detecting resistance Rse to convert a voltage source VIN into an equivalent current source to drive an LED module 30 to light. Mutual connection between the elements and operation thereof in the LED driving circuit are described as following.

The positive terminal of the LED module 30 is coupled to the voltage source VIN, the negative terminal thereof is coupled to a terminal of the inductance L and the other terminal of the inductance L is coupled to a first terminal of the transistor switch SW. The output capacitance C is connected parallel with the LED module 30. The positive terminal of the diode D is coupled to the connection node of the inductance L and the transistor switch SW, and the negative terminal thereof is coupled to the voltage source VIN to freewheel the current from the inductance L when the transistor switch SW is turned off. A second terminal of the transistor switch SW is grounded through the current detecting resistance Rse. The converting controller 10 is coupled to a control terminal of the transistor switch SW and adjusts the power for the LED module 30 by controlling the ratio of the turn-on and turn-off periods of the transistor switch SW.

When the transistor switch SW is turned on, the current from the voltage source VIN flows through the LED module 30, the inductance L, the transistor switch SW and the current detecting resistance Rse to ground. A current detecting signal FB is generated by the current detecting resistance Rse when the current flows therethrough. The converting controller 10 adjusts an amount of the current flowing through the LED module 30 according to the current detecting resistance Rse. When the current flowing through the LED module 30 reaches a preset current value, the converting controller 10 turns the transistor switch SW off for a constant time period. Then, the current from the inductance L freewheels through the diode D and the energies saved on the inductance L and the output capacitance C are released to light the LED module 30. After the constant time period, the converting controller 10 turns on the transistor switch SW again to store energies on the inductance L and the output capacitance C. By the foregoing process, the current flowing through the LED module 30 is kept around an average current value so as to reach the object of stably lighting.

However, when there is anyone LED damaged or abnormal condition in the circuit is happened, no current flows through the LED module 30 and so the LED module is open-circuited and not lighting. If the converting controller 10 keeps operating at this time, it still consumes power. Due to the LED module 30 is open-circuited and do not light, the user may get an electric shock if the user touches the LED module 30 for making sure the condition of the circuit or replacing the LED module with a new one.

### SUMMARY OF THE INVENTION

The conventional LED driving circuit cannot be protected the LEDs from overvoltage. The present invention disclosed an LED driving circuit with open-circuit protection. The LED driving circuit pulls down an operation voltage for a converting controller of the LED driving circuit when a voltage across an LED module of the LED driving circuit is too high, so as to stop the converting controller operating and further latch the converting controller at the protection state until that the converting controller is restart or the voltage across to the LED module being too high is solved.

Furthermore, the invention provides an LED driving circuit with open-circuit protection which comprises an LED module, a converting circuit, a converting controller, an operation voltage generating circuit, an overvoltage detecting circuit and a protecting circuit. The converting circuit is coupled to a voltage source and the LED module. The converting controller controls the converting circuit to provide an electric power to light the LED module according to a current detecting signal representing a current of the LED module. The operation voltage generating circuit is coupled to the voltage source to supply an operation voltage to the converting controller operating. The overvoltage detecting circuit is coupled to the LED module, and generates a open-circuit protecting signal when a voltage across the LED module is higher than a preset voltage protecting value. The protecting circuit is coupled to the operation voltage generating circuit, and decreases the operation voltage to stop the converting controller operating responsive to the open-circuit protecting signal.

It is to be understood that both the foregoing general description and the following detail description are exemplary, and are intended to provide further explanation of the invention as claimed. In order to make the features and the advantages of the invention comprehensible, exemplary embodiments accompanied with figures are described in detail below.

### BRIEF DESCRIPTION OF THE DRAWINGS

The present invention will now be specified with reference to its preferred embodiment illustrated in the drawings, in which:

FIG. 1 is a schematic diagram of an LED driving circuit;

FIG. 2 is a schematic diagram of an LED driving circuit according to a first embodiment of the invention;

FIG. 3 is a schematic diagram of an LED driving circuit according to a second embodiment of the invention.

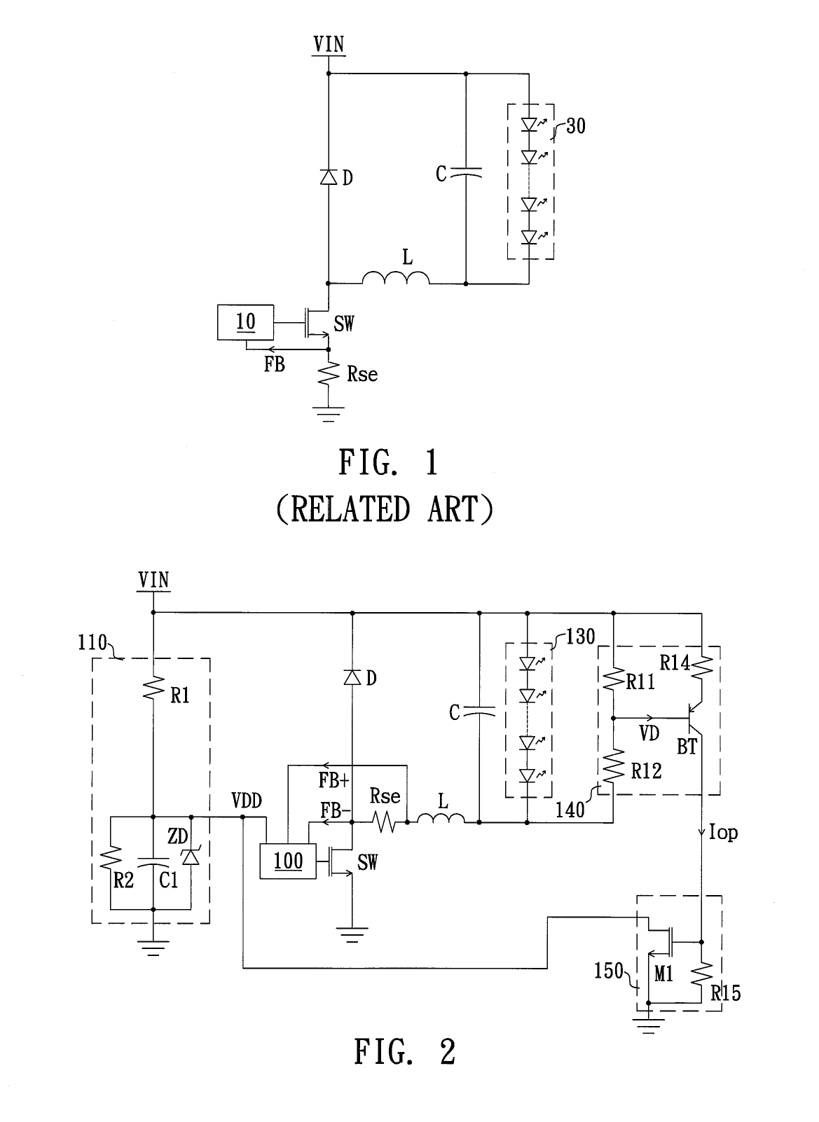

### DESCRIPTION OF EMBODIMENTS

In the following detail description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

FIG. 2 is a schematic diagram of an LED driving circuit according to a first embodiment of the invention. The LED driving circuit comprises a converting controller 100, an operation voltage generating circuit 110, an LED module 130, an overvoltage detecting circuit 140, a protecting circuit 150 and a converting circuit. In the present embodiment, the converting circuit is a buck converting circuit, comprising an inductance L, a diode D, an output capacitance C and a transistor switch SW. The converting circuit is coupled to a voltage source VIN and converts the voltage source VIN into a suitable equivalent current source to drive the LED module 130 to stably light according to the controlling of the converting controller 100. The output capacitance C is connected with the LED module 130 in parallel to filter high frequency noises out to supply a stable power to the LED module 130. The positive terminal of the LED module 130 is coupled to the voltage source VIN, the negative terminal of the LED module 130 is coupled to a terminal of the inductance L. The other terminal of the inductance L is coupled to a first terminal of the transistor switch SW and a positive terminal of the diode D. A negative terminal of the diode D is coupled to the voltage source VIN and is used to be the current freewheeling path for the inductance L when the transistor switch is turned off. A second terminal of the transistor switch SW is grounded and a control terminal thereof is coupled to the converting controller 100 to be turned on or off according to the controlling of the converting controller 100. The current detecting resistance Rse is coupled between the inductance L and the transistor switch SW to generate current detecting signals FB+ and FB−. The converting controller 100 adjusts an amount of the current of the LED module 130 according to the current detecting signal FB+ and FB−. The converting controller 100 turns off the transistor switch SW when the current of the LED module 130 increases to a preset maximal current value and turns on the transistor switch SW when it decreases to the preset minimal current value, wherein the preset maximal current value is higher than the preset minimal current value. Therefore, the LED module 130 lights stably with the current of the LED being controlled between the preset maximal and the preset minimal current values.

The operation voltage generating circuit 110 is coupled to the voltage source VIN to generate an operation voltage VDD to supply the converting controller 100. The operation voltage generating circuit 110 also can be coupled to other voltage source to replace the voltage source Vin to supply the operation voltage VDD. The operation voltage generating circuit 110 comprises two resistances R1 and R2, an input capacitance C1 and a zener diode ZD. The resistance R2, the input capacitance C1 and the zener diode ZD are connected in parallel and coupled to the voltage source VIN through the resistance R1. The input capacitance C1 stores the power electric energy from the voltage source VIN to supply the operation voltage VDD that is determined by a breakdown voltage of the zener diode ZD. The resistance R2 is used to be a releasing path to release the energy stored by the input capacitance C1 when the voltage source VIN is not supplied to the LED driving circuit.

The overvoltage detecting circuit 140 is coupled to the LED module 130 to detect a voltage across the LED module 130 and generates an open-circuit protecting signal Top when determining that the voltage across the LED module 130 is higher than a preset voltage protecting value. The overvoltage detecting circuit 140 comprises three resistances R11, R12, R14 and a bipolar junction transistor BT. The resistances R11 and R12 serves as a voltage divider and are connected with the LED module 130 in parallel to generate a voltage detecting signal VD representing the voltage across the LED module 130. A base of the bipolar junction transistor BT is coupled to a connection node of the resistances R11 and R12 to receive the voltage detecting signal VD. An emitter of the bipolar junction transistor BT is coupled to the voltage source VIN via the resistance R14 and a collector thereof is coupled to the protecting circuit 150. The bipolar junction transistor BT is a PNP-type bipolar junction transistor. The bipolar junction transistor BT is turned on and generates the open-circuit protecting signal Iop when a voltage level of the base is a threshold voltage lower than a voltage level of the emitter thereof.

The protecting circuit 150 is coupled to the overvoltage detecting circuit 140 and the operation voltage generating circuit 110 and makes the operation voltage VDD generated by the operation voltage generating circuit 110 decreasing to put the operation voltage VDD down to be lower than a minimal voltage of the operation voltage of the converting controller 100 and then the converting controller 100 is stopped operating. The protecting circuit 150 comprises a resistance R15 and the transistor M1. A terminal of the resistance R15 is coupled to a control terminal of the transistor M1 and the other terminal thereof is grounded. A first terminal of the transistor M1 is coupled to the operation voltage generating circuit 110 and a second terminal is grounded. When the resistance R15 receives the open-circuit protecting signal Iop to make a voltage level of the control terminal of the transistor M1 to be higher than a threshold voltage of the transistor M1, the transistor M1 is turned on. At this time, the input capacitance C1 in the operation voltage generating circuit 110 is discharged by the transistor M1 and so the operation voltage VDD supplied by the input capacitance C1 is decreased to stop the converting controller 100 operating. Therefore, the converting circuit does not convert the power from the voltage source VIN to drive the LED module 130 anymore, and so the voltage across the LED module 130 is stopped increasing to execute the open-circuit protecting function.

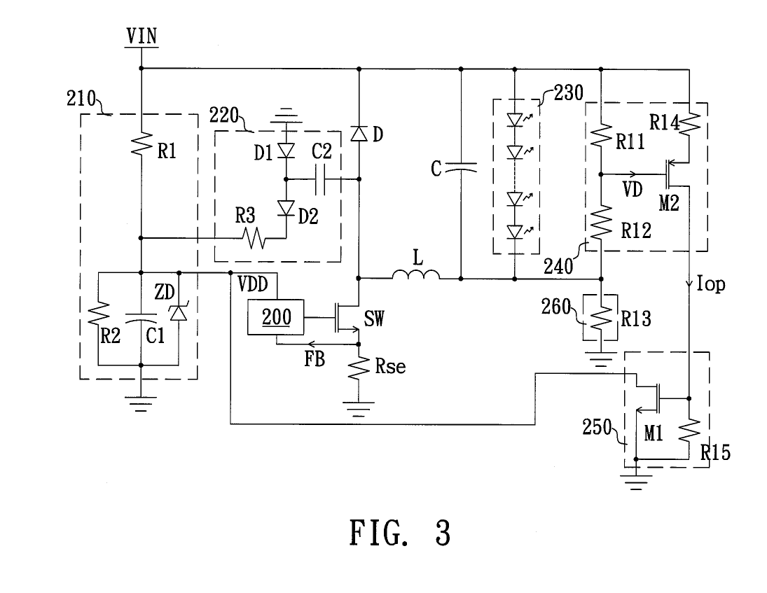

FIG. 3 is a schematic diagram of an LED driving circuit according to a second embodiment of the invention. The LED driving circuit comprises a converting controller 200, an operation voltage generating circuit 210, a power delivering circuit 220, an LED module 230, an overvoltage detecting circuit 240, a protecting circuit 250, a latch circuit 260 and a converting circuit. The converting circuit is coupled to the voltage source VIN and comprises an inductance L, a diode D, an output capacitance C and a transistor switch SW. The converting controller 200 controls the operation of the converting circuit to supply the power to drive the LED module 230 to light stably according to a current detecting signal FB representing an amount of a current of the LED module 230. In the present embodiment, the overvoltage detecting circuit 240 replaces the bipolar junction transistor BT with the transistor M2 of the embodiment shown in the FIG. 2.

In the present embodiment, the main differences between the LED driving circuit in the embodiment is and that in FIG. 2 are the power delivering circuit 220 and the latch circuit 260. The following will describe the main differences.

The latch circuit 260 is coupled between the overvoltage detecting circuit 240 and a common potential (it is the ground potential here) to supply a return path for an overvoltage detecting circuit 240. In the present embodiment, the latch circuit 260 comprises a resistance R13. A terminal of the resistance R13 is coupled to the resistance R12 in the overvoltage detecting circuit 240 and the other terminal is grounded. When the voltage across the LED module 230 is over high, the overvoltage detecting circuit 240 generates an open-circuit protecting signal Iop to decrease the operation voltage VDD through the protecting circuit 250 and so the operation of converting controller 200 is stopped because the operation voltage VDD is insufficient. If there is not the latch circuit 260 in the converting circuit, the converting circuit is stopped to convert the power from the voltage source VIN, and so the voltage of the output capacitance C is gradually decreased because of current leakage path in the converting circuit. Therefore, the overvoltage detecting circuit 240 may incorrectly determines that the overvoltage issue is removed and so turns the transistor M1 in the protecting circuit 250 off. It results that the operation voltage VDD supplied by the operation voltage generating circuit 210 increases again and so the converting controller 200 re-operates and the overvoltage issue occurs again. In the present embodiment, the latch circuit 260 is also coupled to the output capacitance C in the converting circuit and maintains a voltage across the output capacitance C to be higher than the preset voltage protecting value once the voltage across the LED module is higher than the preset voltage protecting value. The latch circuit 260 supplies a current from the voltage source Vin into the overvoltage detecting circuit 240 to make the overvoltage detecting circuit 240 keep generating open-circuit protecting signal Top. At this time, the voltage across the output capacitance C is determined by a voltage divider ratio of a voltage divider composed of the resistances R11 and R12 in the overvoltage detecting circuit 240 and the resistance R13 in the latch circuit 260, i.e.; vin*(r11+r12)/(r11+r12+r13), wherein the vin is the voltage of the voltage source VIN and r11, r12 and r13 are the resistance values of the resistance R11, R12 and R13 separately. The vin*(r11+r12)/(r11+r12+r13) must be higher than the preset voltage protecting value to make the overvoltage detecting circuit 240 keep generating the open-circuit protecting signal Iop after the voltage across the LED module is higher than the preset voltage protecting value. Therefore, the LED driving circuit is latched at a protecting state before the cause of the voltage across the LED module higher than the preset voltage protecting value, such as, open-circuit, is solved for avoiding the personnel safety for the user. When the voltage across the LED module higher than the preset voltage protecting value is solved and the power supplied by the latch circuit 260 cannot supplies the LED module 230 lighting without decreasing the current voltage of the output capacitance C. Therefore, the voltage across the output capacitance C is decreased to make the overvoltage detecting circuit 240 stop generating open-circuit protecting signal Iop and so the transistor M1 in the protecting circuit 250 is turned off. Then, the operation voltage VDD rises again to remove the protecting state of the LED driving circuit and the converting controller 200 re-operates.

The power delivering circuit 220 is coupled between the converting circuit and the operation voltage generating circuit 210. When the converting circuit converts the voltage source into the current source to drive the LED module 230 to light, the power delivering circuit 220 delivers energy into the input capacitance C1 in the operation voltage generating circuit 210. Therefore, the resistance value of the resistance R1 in the operation voltage generating circuit 210 may be setup larger to decrease the power consumption of the operation voltage generating circuit 210 when the LED driving circuit is not operating. The insufficient power supplied by the operation voltage generating circuit 210 may be complemented by the power delivering circuit 220. The diodes D1, D2 and the resistance R3 are connected in series between the ground potential and the negative terminal of the zener diode ZD in the operation voltage generating circuit 210. The capacitance C2 is coupled to the positive terminal of the diode D in the converting circuit and the connection point of the diodes D1 and D2. When the transistor switch SW in the converting circuit is turned on, the capacitance C2 stores energy from the diode D1. When the transistor switch SW in the converting circuit is turned off, a voltage level of the positive terminal of the diode D is increased and slightly higher the voltage source VIN. At this time, the capacitance C2 releases the energy stored therein to the operation voltage generating circuit 210 through the diode D2.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An LED driving circuit with open-circuit protection, comprising:
an LED module;
a converting circuit, coupled to a voltage source and the LED module;
a converting controller, controlling the converting circuit to provide an electric power to light the LED module according to a current detecting signal representing a current of the LED module;
an operation voltage generating circuit, coupled to the voltage source and supplying an operation voltage to the converting controller;
an overvoltage detecting circuit, coupled to the LED module, and generating a open-circuit protecting signal when a voltage across the LED module is higher than a preset voltage protecting value;
a protecting circuit, coupled to the operation voltage generating circuit and decreasing the operation voltage to stop the converting controller operating responsive to the open-circuit protecting signal.

2. The LED driving circuit with open-circuit protection according to claim 1, further comprising a power delivering circuit coupled between the converting circuit and the operation voltage generating circuit, wherein the energy returning circuit supplies an electric power to the operation voltage when the converting circuit is operating.

3. The LED driving circuit with open-circuit protection according to claim 1, further comprising a latch circuit coupled to the overvoltage detecting circuit and a common potential;
wherein the latch circuit supplies a current to the overvoltage detecting circuit to keep the overvoltage detecting circuit generating the open-circuit protecting signal once the voltage across the LED module is higher than the preset voltage protecting value.

4. The LED driving circuit with open-circuit protection according to claim 3, further comprising a power delivering circuit coupled between the converting circuit and the operation voltage generating circuit, wherein the energy returning circuit supplies an electric power to the operation voltage when the converting circuit is operating.

5. The LED driving circuit with open-circuit protection according to claim 3, wherein the overvoltage detecting circuit comprises a voltage divider and a transistor connected in parallel, and the transistor supplies an open-circuit protecting current to be as the open-circuit protecting signal when the voltage across the LED module exceeding the preset voltage protecting value.

6. The LED driving circuit with open-circuit protection according to claim 5, wherein the protecting circuit comprises a resistance and a transistor, in which a terminal of the resistance is coupled to a control terminal of the transistor and the other terminal of the resistance is coupled to a common potential, a first terminal of the transistor is coupled to the operation voltage generating circuit, a second terminal of the transistor is coupled to the other terminal of the resistance, and the transistor is turned on when the open-circuit protecting current flows through the resistance.

7. The LED driving circuit with open-circuit protection according to claim 1, more comprising a latch circuit, wherein the converting circuit comprises an output capacitance for stabilizing the power supplied by the converting circuit, and the latch circuit is coupled to the output capacitance and keeps the voltage of the output capacitance to be higher than the preset voltage protecting value once the voltage across the LED module is higher than the preset voltage protecting value.

8. The LED driving circuit with open-circuit protection according to claim 7, further comprising a power delivering circuit coupled between the converting circuit and the operation voltage generating circuit, wherein the energy returning circuit supplies an electric power to the operation voltage when the converting circuit is operating.

9. The LED driving circuit with open-circuit protection according to claim 7, wherein both of the latch circuit and the overvoltage detecting circuit comprise at least one resistance, and the voltage of the output capacitance is determined according to resistance values of the resistance once the voltage across the LED module is higher than the preset voltage protecting value.

10. The LED driving circuit with open-circuit protection according to claim 9, further comprising a power delivering circuit coupled between the converting circuit and the operation voltage generating circuit, wherein the energy returning circuit supplies an electric power to the operation voltage when the converting circuit is operating.

11. The LED driving circuit with open-circuit protection according to claim 7, wherein the overvoltage detecting circuit comprises a voltage divider and a transistor connected in parallel, and the transistor supplies an open-circuit protecting current to be as the open-circuit protecting signal when the voltage across the LED module exceeding the preset voltage protecting value.

12. The LED driving circuit with open-circuit protection according to claim 11, wherein the protecting circuit comprises a resistance and a transistor, in which a terminal of the resistance is coupled to a control terminal of the transistor and the other terminal of the resistance is coupled to a common potential, a first terminal of the transistor is coupled to the operation voltage generating circuit, a second terminal of the transistor is coupled to the other terminal of the resistance, and the transistor is turned on when the open-circuit protecting current flows through the resistance.
